(19) United States
(12) Patent Application Publication
(10) Pub. No.: US 2010/0322167 A1
(43) Pub. Date: Dec. 23, 2010

(54) MOBILE COMMUNICATION DEVICE AND METHOD FOR ESTIMATING RADIO RESOURCE ALLOCATED TO MOBILE COMMUNICATION DEVICE

(75) Inventor: Kengo KUROSE, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 12/700,972

(22) Filed: Feb. 5, 2010

(30) Foreign Application Priority Data
Jun. 19, 2009 (JP) 2009-146793

(51) Int. Cl. H04W 72/04

(52) U.S. Cl. 370/329

(57) ABSTRACT

A mobile communication device to which a radio resource is allocated by one of a plurality of base stations included in a network, upon the network including the mobile communication device as one of a plurality of mobile stations connected to the network, is provided. The mobile communication device includes an allocation state detector which detects a radio resource that each of the base stations allocates to each of the mobile stations other than the mobile communication device, an allocation estimator which estimates a radio resource quantity which can be allocated to the mobile communication device on the basis of the radio resource detected by the allocation state detector, and a display unit which displays data related to the radio resource quantity estimated by the allocation estimator for each of the base stations.

### CROSS REFERENCE TO RELATED APPLICATIONS

This application is based upon and claims the benefit of priority from the prior Japanese Patent Application No. 2009-146793 filed on Jun. 19, 2009;

the entire contents of which are incorporated herein by reference.

### BACKGROUND OF THE INVENTION

1. Field of the Invention

The present invention relates to a mobile communication device which communicates by radio with a base station subsystem included in a network, and to a method for estimating a radio resource allocated to the mobile communication device.

2. Description of the Related Art

Services according to the mobile WiMAX standard (IEEE 802.16e) approved by IEEE (The Institute of Electrical and Electronics Engineers, Inc.) similarly as wireless local area networks (WLAN) are taking off in recent years, as shown in standards IEEE 802.16-2004 and IEEE 802.16e-2005. The mobile WiMAX standard much differs from the WLAN standard in that a system is designed in a wireless communication environment in which participants of the system can move, and that a cell radius and moving speed are specified up to 3 km and 120 km/h, respectively.

At a beginning stage of the service, a wireless device of a PC card type will be provided to be used for laptop PCs. Wireless modules to be mounted on other small-sized terminals will gradually be provided.

A mobile WiMAX terminal is placed as a version evolved from a WLAN terminal that can be operated while moving. Thus, according to an assumed procedure, the mobile WiMAX terminal performs an initial search for a base station similarly as a WLAN terminal does, instead of being automatically connected to a provider's network under contract similarly as a mobile phone does at present. Then, the mobile WiMAX terminal measures a received downlink signal level and indicates the level on a bar, and a user selects a desired provider (or base station) and makes a connection upon seeing the above indication. Such a connection process is performed by a connection manager that is run on the terminal.

Further, in recent years, a mobile communication service using adaptive modulation technology is taking off in a field of mobile communication. According to this service, a base station allocates frequency resources to individual mobile stations on a best effort basis on the basis of received quality measurement data of the individual mobile stations in a coverage area of the base station.

To put it specifically, according to a communication system adopting the above adaptive modulation technology, a mobile station measures quality of a currently received downlink signal and feeds measured data back to the base station. Then, the base station uses a best effort type scheduler on the basis of the received signal quality notified by the individual mobile stations, and determines for a mobile station with which the base station communicates a combination of a frequency resource size, a modulation method and an error correction coding ratio (MCS).

Then, the base station notifies the mobile station of identification data of the mobile station associated with the MCS and a frequency resource position through a notification channel. Upon receiving the data including the own identification data through the notification channel, the mobile station receives transmitted data through a resource allocated to the mobile station itself and decodes the data. In general, the mobile station is also notified of a minimum unit of a frequency resource to be used for one user (or one service) on this occasion.

Thus, if there are lots of mobile stations (users) in the coverage area, the base station allocates limited frequency resources to the individual mobile stations so as to provide lots of the mobile stations with the service. If there are not many mobile stations in the coverage area, in contrast, the mobile station can allocate more frequency resources to the individual mobile stations. Thus, as the mobile stations increase in the coverage area, a received downlink data rate decreases even if received downlink signal quality does not change.

An OFDMA system is known as an example of a system which adopts the adaptive modulation technology. A wireless system which uses the OFDMA system and is being standardized in recent years can deal with a plurality of system bands. Thus, generally in the wireless system, a mobile station first sets up frequency synchronization and time synchronization with a base station, and then the mobile station receives notification data from the base station so as to take hold of a system band and to start communication.

In the wireless system which uses the adaptive modulation technology, however, a frequency resource allocated to a mobile station varies a lot depending, e.g., upon the number of users in a coverage area. Thus, a received downlink data rate does not necessarily increase even if quality or a level of the downlink received signal is sufficient.

Thus, there is a problem in that a mobile station located at a place where coverage areas of a plurality of base stations overlap does not necessarily enjoy an increase of a received downlink data rate even if selecting a base station on the basis of quality or a level of the received downlink signal.

There is ordinarily a problem in that a mobile station located at a place where coverage areas of a plurality of base stations overlap does not necessarily enjoy an increase of a received downlink data rate even if selecting a base station on the basis of quality or a level of the received downlink signal.

### SUMMARY OF THE INVENTION

Accordingly, an advantage of the present invention is to provide a mobile communication device which enables a user to identify a base station providing a high downlink received data rate even if the mobile communication device is located at a place where coverage areas of a plurality of base stations overlap.

To achieve the above advantage, one aspect of the present invention is that a mobile communication device to which a radio resource is allocated by one of a plurality of base stations included in a network, upon the network including the mobile communication device as one of a plurality of mobile stations connected to the network, is provided. The mobile communication device includes an allocation state detector which detects a radio resource that each of the base stations allocates to each of the mobile stations other than the mobile communication device, an allocation estimator which estimates a radio resource quantity which can be allocated to the mobile communication device on the basis of the radio resource detected by the allocation state detector, and a display unit which displays data related to the radio resource quantity estimated by the allocation estimator for each of the base stations.

### BRIEF DESCRIPTION OF THE DRAWINGS

FIG. 1 is a circuit block diagram showing a configuration of a mobile communication device of an embodiment of the invention.

FIG. 2 shows an example of coverage areas of base station subsystems which communicate with the mobile communication device shown in FIG. 1.

FIG. 3 is a flowchart illustrating an operation of the mobile communication device related to a first embodiment.

FIG. 4 is a flowchart illustrating an operation of the mobile communication device related to a second embodiment.

FIG. 5 shows an example of histograms that the mobile communication device related to the second embodiment makes.

### DETAILED DESCRIPTION OF THE INVENTION

Embodiments of the present invention will be explained with reference to the drawings, hereafter.

### First Embodiment

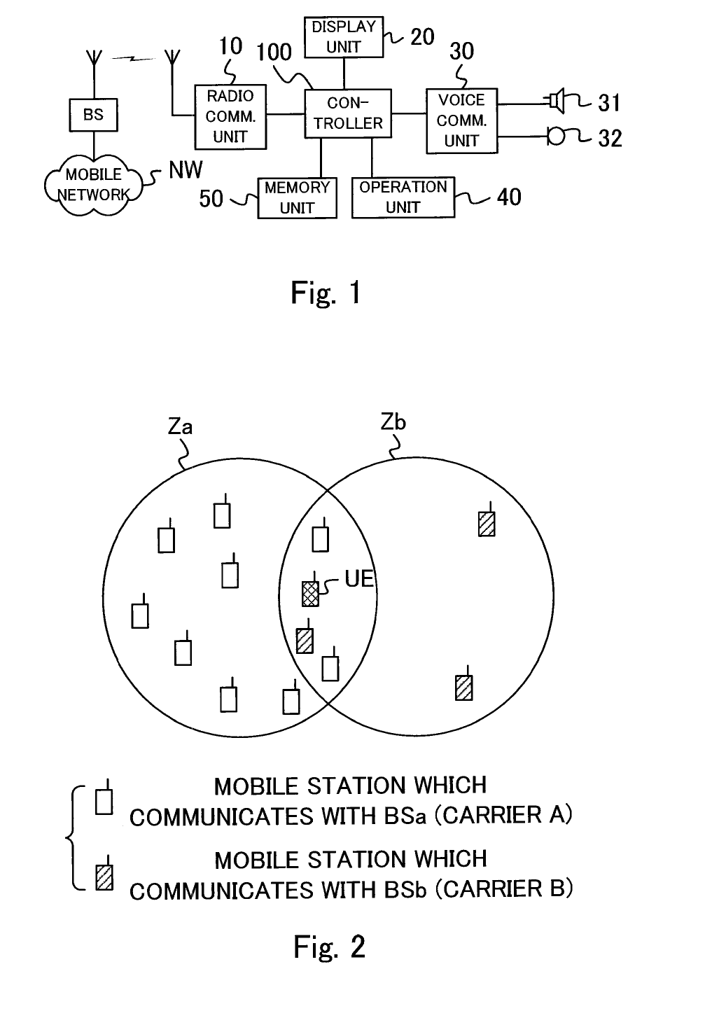

FIG. 1 is a block diagram which shows a configuration of a mobile communication device named UE of a first embodiment of the invention. The mobile communication device UE is used in a mobile electronic device such as a mobile phone. The mobile communication device UE has main portions which are a controller 100, a radio communication unit 10, a display unit 20, a voice communication unit 30, an operation unit 40 and a memory unit 50.

The mobile communication device UE has a function for communicating with a base station named BS by radio by means of a communication system in accordance with the mobile WiMAX standard (IEEE 802.16e) and for performing communication through a mobile network named NW.

The radio communication unit 10 communicates with the base station BS included in the mobile network NW by radio as controlled by the controller 100. The radio communication unit 10 sends and receives voice data and email data, and receives Web data and streaming data. The radio communication unit 10 measures a received power level in a frequency range specified by the controller 100, and notifies the controller 100 of the measured power level.

The display unit 20 displays an image (still or moving) and text so as to transfer visual data to a user.

The voice communication unit 30 has a speaker 31 and a microphone 32. The voice communication unit 30 converts a user's voice into voice data to be processed by the controller 100 and provides the controller 100 with the voice data, and decodes voice data received from someone the user is speaking to and provides the speaker 31 with decoded voice. The operation unit 40 has a plurality of key switches and accepts an instruction from the user through the key switches.

In the memory unit 50, programs and data such as a control program and control data of the controller 100, application software, address data including people's names associated with their respective phone numbers, data of sent and received emails, Web data downloaded while browsing and downloaded content data are stored, and streaming data is temporarily stored. The memory unit 50 includes one or more of memory devices such as an HDD, a RAM, a ROM, an IC memory and so on.

The controller 100 having a microprocessor works in accordance with the control program and control data stored in the memory unit 50 and exercises supervisory control over respective portions of the mobile communication device UE. The controller 100 has a communication control function for controlling each of portions of a communication subsystem for performing, e.g., voice or data communication. The controller 100 has an application control function for running email software for making, sending and receiving emails, browser software for Web browsing, and media play software for downloading and playing streaming data, and for controlling respective portions related to the applications.

Then, an operation of the mobile communication device UE of the first embodiment will be explained. In the following explanation, a communication process performed after the mobile communication device UE is connected to the base station is omitted to explain, and an access point selection process performed before starting communication is explained. According to the access point selection process, the mobile communication device UE shows a user a list of base stations to which the mobile communication device UE can be connected so that the user can select a base station to which the mobile communication device UE is connected.

Further, in the following explanation, it is assumed that the mobile communication device UE is put in an environment shown in FIG. 2. That is, the mobile communication device UE is located in an area where a coverage area Za formed by a base station subsystem BSa and a coverage area Zb formed by a base station subsystem BSb overlap, and where the mobile communication device UE can communicate with both of the base station subsystems. It is assumed that the mobile communication device UE can obtain a higher received power level from the base station subsystem BSa than from the base station subsystem BSb, and that more mobile communication devices exist in the coverage area Za than in the coverage area Zb.

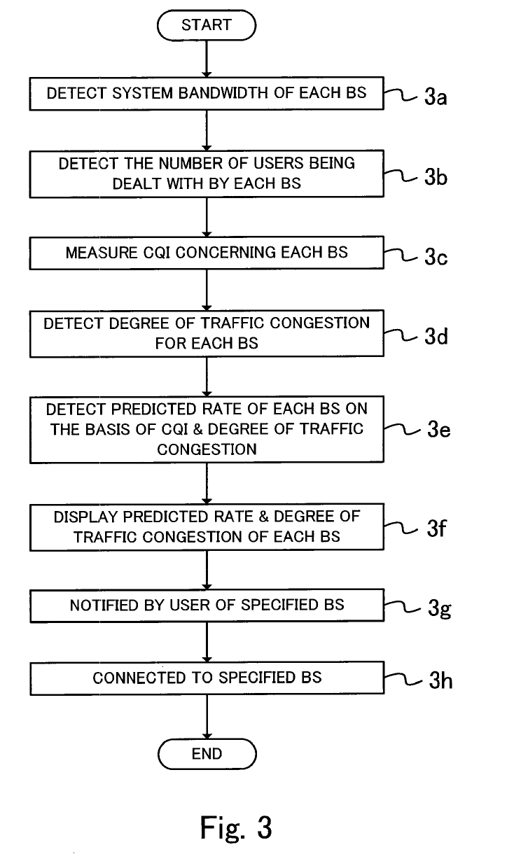

FIG. 3 is a flowchart for explaining the access point selection process. The controller 100 works in accordance with a control program and control data stored in the memory unit 50 so as to implement the process. That is, a control program and control data of the access point selection process are stored in the memory unit 50. The process starts upon the mobile communication device UE being supplied with power or being provided with a communication request from the user.

First, at a step 3a, the controller 100 controls the radio communication unit 10 so as to receive a signal on a notification channel provided at a top of a time-divided frame which each of the base station subsystems regularly transmits. The controller 100 detects a system bandwidth Fw of each of the base station subsystems from data notified through the notification channel. Further, the controller 100 measures a received power level P for a system band of each of the base station subsystems, and shifts to a step 3b.

That is, for the example shown in FIG. 2, the controller 100 detects a system bandwidth Fw_a of the base station subsystem BSa as being 5 MHz, and on the other hand detects a system bandwidth Fw_b of the base station subsystem BSb as being 10 MHz. Further, the controller 100 measures received power levels P_a and P_b for the system bands of the base station subsystems BSa and BSb, respectively.

At the step 3b, the controller 100 controls the radio communication unit 10 so as to receive a DL-MAP signal that each of the base stations transmits, detects N, i.e., the number of users being dealt with by each of the base stations, and shifts to a step 3c. That is, for the example shown in FIG. 2, the controller 100 detects N_a, i.e., the number of mobile communication devices located in the coverage area Za and communicating with the base station subsystem BSa, and N_b, i.e., the number of mobile communication devices located in the coverage area Zb and communicating with the base station subsystem BSb.

At the step 3c, the controller 100 controls the radio communication unit 10 so as to receive a known signal transmitted by each of the base station subsystems through the notification channel, measures a channel quality indicator (CQI) and shifts to a step 3d. That is, for the example shown in FIG. 2, the controller 100 receives a signal transmitted from the base station subsystem BSa through the notification channel, and measures CQI_a, i.e., a CQI for the base station subsystem BSa. Further, the controller 100 receives a signal transmitted from the base station subsystem BSb through the notification channel, and measures CQI_b, i.e., a CQI for the base station subsystem BSb as well.

At the step 3d, the controller 100 computes a degree of traffic congestion Tr for each of the base station subsystems on the basis of the system bandwidth and the number of users detected at the steps 3a and 3b, respectively, and shifts to a step 3e. That is, for the example shown in FIG. 2, the controller 100 computes a degree of traffic congestion Tr_a for the base station subsystem BSa as Fw_a/N_a, and similarly computes a degree of traffic congestion Tr_b for the base station subsystem BSb as Fw_b/N_b.

At the step 3e, the controller 100 predicts for each of the base stations a data rate provided by a radio resource allocated to the mobile communication device on the basis of the CQI and the degree of traffic congestion Tr obtained at the steps 3c and 3d, respectively, so as to obtain a predicted rate Er and shifts to a step 3f. That is, for the example shown in FIG. 2, the controller 100 computes a predicted rate Er_a from CQI_a/Tr_a for the base station subsystem BSa, and similarly computes a predicted rate Er_b from CQI_b/Tr_b for the base station subsystem BSb.

At the step 3f, the controller 100 controls the display unit 20 so as to display a list of identification data of base station subsystems with which the mobile communication device can communicate. Further, the controller 100 displays data such as the received power level P, the predicted rate Er, the degree of traffic congestion Tr and the system bandwidth Fw in association with the identification data, and shifts to a step 3g. That is, for the example shown in FIG. 2, the controller 100 displays respective identification data of the base station subsystems BSa and BSb, and displays the data obtained through the steps 3a-3e in association with the identification data. A user can thereby get hold of an operation state and a data rate predicted upon being connected as well as a received power level of a base station that the mobile communication device can communicate with.

At the step 3g, the controller 100 accepts specification of a base station to be connected with from the user through the operation unit 40, and shifts to a step 3h. For the example shown in FIG. 2, e.g., as being located closer to the base station subsystem BSa than to the base station subsystem BSb, the mobile communication device detects higher received power level from the base station subsystem BSa than from the base station subsystem BSb. The user understands with reference to the data displayed at the step 3f, however, that the mobile communication device does not necessarily communicate with the base station subsystem BSa at a higher data rate than with the base station subsystem BSb.

At the step 3h, the controller 100 controls the radio communication unit 10 so as to be connected to the base station subsystem specified at the step 3g, and starts communication through the base station. On this occasion, e.g., if the user specifies the base station subsystem BSb at the step 3g on the basis of the traffic congestion on the base station subsystem BSa, the controller 100 controls the radio communication unit 10 so as to be connected to the base station subsystem BSb.

The mobile communication device configured as described above notifies a user of data such as the system bandwidth Fw, the degree of traffic congestion Tr and the data rate predicted upon being connected Er as well as the received power level for a base station subsystem that the mobile communication device can be connected to. Hence, as the user can know operation states of the respective base station subsystems before connection, the user can select a base station with which a high downlink received data rate can be obtained even if the mobile communication device is located at a place where coverage areas of a plurality of base station subsystems overlap.

### Second Embodiment

Then, a mobile communication device UE of a second embodiment will be explained. As a configuration of the mobile communication device UE of the second embodiment is apparently a same as that of the first embodiment, the configuration of the second embodiment will be explained with reference to FIG. 1. In the following explanation, a communication process performed after the mobile communication device UE is connected to the base station is omitted to explain, and an access point selection process performed before starting communication is explained. According to the access point selection process, the mobile communication device UE shows a user a list of base stations to which the mobile communication device UE can be connected so that the user can select a base station to which the mobile communication device UE is connected. Further, in the following explanation, it is assumed similarly as the first embodiment that the mobile communication device UE is put in an environment shown in FIG. 2.

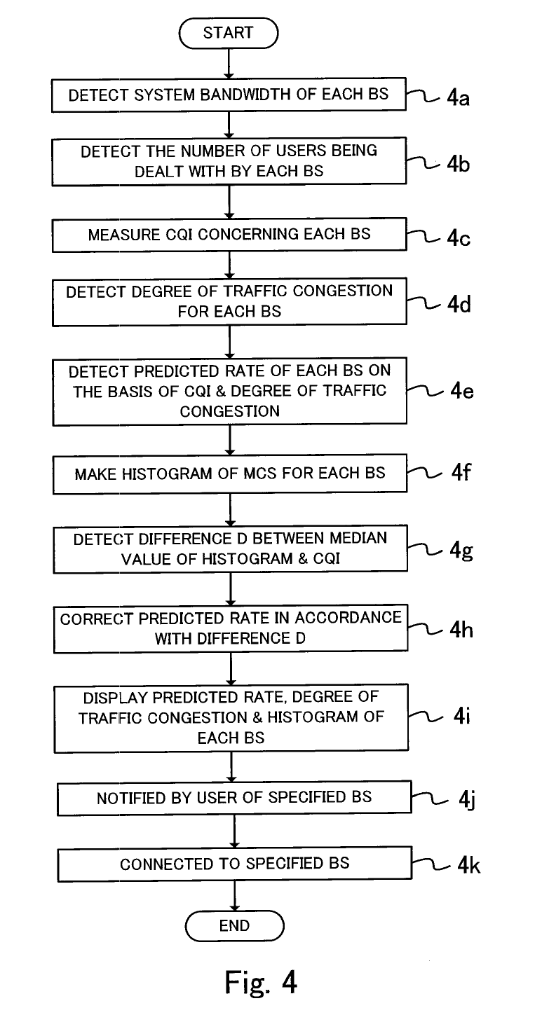

FIG. 4 is a flowchart for explaining the access point selection process. The controller 100 works in accordance with a control program and control data stored in the memory unit 50 so as to implement the process. That is, a control program and control data of the access point selection process are stored in the memory unit 50. The process starts upon the mobile communication device UE being supplied with power or being provided with a communication request from the user.

First, at a step 4a, the controller 100 controls the radio communication unit 10 so as to receive a signal on a notification channel which each of the base station subsystems regularly transmits. The controller 100 detects a system bandwidth Fw of each of the base station subsystems from data notified through the notification channel. Further, the controller 100 measures a received power level P for a system band of each of the base station subsystems, and shifts to a step 4b.

That is, for the example shown in FIG. 2, the controller 100 detects a system bandwidth Fw_a of the base station subsystem BSa as being 5 MHz, and on the other hand detects a system bandwidth Fw_b of the base station subsystem BSb as being 10 MHz. Further, the controller 100 measures received power levels P_a and P_b for the system bands of the base station subsystems BSa and BSb, respectively.

At the step 4b, the controller 100 controls the radio communication unit 10 so as to receive an MCS (modulation and coding set) of a mobile communication device communicating with each of the base stations. The controller 100 detects N, i.e., the number of users of each of the base stations on the basis of the received MCS, and shifts to a step 4c. That is, for the example shown in FIG. 2, the controller 100 detects N_a, i.e., the number of mobile communication devices located in the coverage area Za and communicate with the base station subsystem BSa, and N_b, i.e., the number of mobile communication devices located in the coverage area Zb and communicate with the base station subsystem BSb.

At the step 4c, the controller 100 controls the radio communication unit 10 so as to receive a known signal such as a pilot signal from each of the base station subsystems, measures a CQI (channel quality indicator) and shifts to a step 4d. That is, for the example shown in FIG. 2, the controller 100 receives a known signal transmitted by the base station subsystem BSa so as to measure CQI_a, i.e., a CQI for the base station subsystem BSa, and receives a known signal transmitted by the base station subsystem BSb so as to measure CQI_b, i.e., a CQI for the base station subsystem BSb as well.

At the step 4d, the controller 100 computes a degree of traffic congestion Tr for each of the base station subsystems on the basis of the system bandwidth and the number of users detected at the steps 4a and 4b, respectively, and shifts to a step 4e. That is, for the example shown in FIG. 2, the controller 100 computes a degree of traffic congestion Tr_a for the base station subsystem BSa as Fw_a/N_a, and similarly computes a degree of traffic congestion Tr_b for the base station subsystem BSb as Fw_b/N_b.

At the step 4e, the controller 100 predicts for each of the base stations a data rate provided by a radio resource allocated to the mobile communication device on the basis of the CQI and the degree of traffic congestion Tr obtained at the steps 4c and 4d, respectively, so as to obtain an initial predicted rate Er0 and shifts to a step 4f. That is, for the example shown in FIG. 2, the controller 100 computes an initial predicted rate Er0_{—}a from CQI_a/Tr_a for the base station subsystem BSa, and similarly computes an initial predicted rate Er0_{—}b from CQI_b/Tr_b for the base station subsystem BSb.

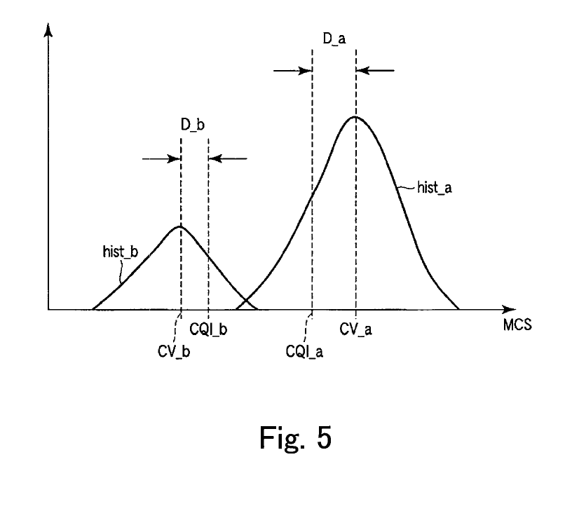

At the step 4f, the controller 100 makes a histogram “hist” (frequency distribution) on the basis of the MCS obtained at the step 4b for each of the base stations, and shifts to a step 4g. That is, for the example shown in FIG. 2, the controller 100 computes histograms hist_a and hist_b of the MCS of mobile communication devices which communicate with the base station subsystems BSa and BSb, respectively. Assume, on this occasion, that histograms shown in FIG. 5 are made.

At the step 4g, the controller 100 computes for each of the base station subsystems a median (or average) value CV of the histogram computed at the step 4f as well as a difference between the median value CV and the CQI obtained at the step 4c, i.e., D=CQI*k−CV (where k is a constant), and shifts to a step 4h. That is, for the example shown in FIG. 2, the controller 100 computes for the base station subsystem BSa a median value CV_a of hist_a as well as a difference between the median value CV_a and CQI_a obtained at the step 4c, i.e., D_a=CQI_a*k−CV_a. The controller 100 similarly computes for the base station subsystem BSb a median value CV_b of hist_b as well as a difference between the median value CV_b and CQI_b obtained at the step 4c, i.e., D_b=CQI_b*k−CV_b.

At the step 4h, the controller 100 corrects the initial predicted rate Er0 computed at the step 4e by multiplying Er0 by a correaction coefficient w according to the difference D computed at the step 4g so as to compute a predicted rate Er=Er0*w. For the example shown in FIG. 2, the controller 100 corrects the initial predicted rate Er0_{—}a computed at the step 4e by multiplying Er0_{—}a by a correction coefficient w_a according to the difference D_a computed at the step 4g so as to compute a predicted rate Er_a=Er0_{—}a*w_a. The controller 100 similarly corrects the initial predicted rate Er0_{—}b computed at the step 4e by multiplying Er0_{—}b by a correction coefficient w_b according to the difference D_b computed at the step 4g so as to compute a predicted rate Er_{—}b=Er0_{—}b*w_b.

If the difference D equals 0, let the correction coefficient w be 1. If the difference D is greater than 0, let the correction coefficient w be greater than 1 and smaller than 2 in accordance with the difference D. If the difference D is smaller than 0, let the correction coefficient w be greater than 0 and smaller than 1 in accordance with the difference D. In order to simplify the process, the correction coefficient w may be set to 1, 1.5 and 0.5 if the difference D is equal to, greater than and smaller than 0, respectively.

For the example shown in FIG. 2, as the histograms hist_a and hist_b are located with respect to CQI_a and CQI_b, respectively, values smaller than 1 and greater than 1 are set to the correction coefficients w_a and w_b, respectively. Hence, the initial predicted values Er0_{—}a and Er0_{—}b are corrected to smaller and greater values, respectively.

At the step 4i, the controller 100 controls the display unit 20 so as to display a list of identification data of base station subsystems with which the mobile communication device can communicate. Further, the controller 100 displays data such as the received power level P, the predicted rate Er, the degree of traffic congestion Tr and the system bandwidth Fw in association with the identification data, and shifts to a step 4j. That is, for the example shown in FIG. 2, the controller 100 displays respective identification data of the base station subsystems BSa and BSb, and displays the data obtained through the steps 4a-4h in association with the identification data. A user can thereby get hold of an operation state and a data rate predicted upon being connected as well as a received power level of a base station that the mobile communication device can communicate with.

At the step 4j, the controller 100 accepts specification of a base station to be connected with from the user through the operation unit 40, and shifts to a step 4k. For the example shown in FIG. 2, e.g., as being located closer to the base station subsystem BSa than to the base station subsystem BSb, the mobile communication device detects higher received power level from the base station subsystem BSa than from the base station subsystem BSb. The user understands with reference to the data displayed at the step 4i, however, that the mobile communication device does not necessarily communicate with the base station subsystem BSa at a higher data rate than with the base station subsystem BSb.

At the step 4k, the controller 100 controls the radio communication unit 10 so as to be connected to the base station subsystem specified at the step 4j, and starts communication through the base station. On this occasion, e.g., if the user specifies the base station subsystem BSb at the step 4j on the basis of the traffic congestion on the base station subsystem BSa, the controller 100 controls the radio communication unit 10 so as to be connected to the base station subsystem BSb.

The mobile communication device configured as described above notifies a user of data such as the system bandwidth Fw, the degree of traffic congestion Tr, the histogram of the MCS of mobile communication devices which communicate with each of the base stations, and the data rate Er corrected on the basis of the histogram and the CQI as well as the received power level for a base station subsystem that the mobile communication device can be connected to.

Hence, as the user can know operation states of the respective base station subsystems before connection, the user can select a base station with which a high downlink received data rate can be obtained even if the mobile communication device is located at a place where coverage areas of a plurality of base station subsystems overlap.

Incidentally, the invention is not limited to the above embodiments as they are, and can be implemented at a practical phase by modifying included portions within the scope of the invention. Further, the plural members disclosed for the above embodiments can be properly combined so that various inventions can be created. Further, some of the members can be conceivably removed from all the members included in the embodiments. Moreover, the members of the different embodiments can be properly combined.

According to the embodiments, e.g., just once the number of users is counted, the MCS is received, the CQI is measured, the degree of traffic congestion or the predicted rate is computed, and the MCS histogram is made, as described above. Instead, these processes can be severally performed for a plurality of frames so that respective average values may be computed.

According to the embodiments, the mobile communication device counts the number of users and computes the median (or average) value of the MCS histogram, as described above. Instead, e.g., each of the base stations can count the number of users, detect a remaining quantity of resources that can be allocated, and compute the median (or average) value of the MCS histogram, so that the mobile communication device is provided with and uses such data. Other than the above, the invention can be similarly implemented upon being variously modified within the scope of the invention.

The present invention is not limited to the above embodiments, and can be implemented by including a modification of each of the portions within the scope of the present invention. The invention may be variously formed by properly combining a plurality of the portions disclosed as to the above embodiments. Some of the portions may be removed from each of the above embodiments.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication device to which a radio resource is allocated by one of a plurality of base stations included in a network upon the network including the mobile communication device as one of a plurality of mobile stations connected to the network, comprising:
an allocation state detector which detects a radio resource that each of the base stations allocates to each of the mobile stations other than the mobile communication device;
an allocation estimator which estimates a radio resource quantity which can be allocated to the mobile communication device on the basis of the radio resource detected by the allocation state detector; and
a display unit which displays data related to the radio resource quantity estimated by the allocation estimator for each of the base stations.

2. The mobile communication device according to claim 1, further comprising a quality detector which detects a quality of a signal received from each of the base stations, wherein
the allocation estimator estimates the radio resource quantity which can be allocated to the mobile communication device on the basis of the radio resource detected by the allocation state detector and the received signal quality detected by the quality detector.

3. The mobile communication device according to claim 1, further comprising:
a quality detector which detects a quality of a signal received from each of the base stations;
a notification receiver which receives data notified by the base station to one of the mobile stations other than the mobile communication device, the notified data indicating a received signal quality; and
a corrector which corrects the radio resource quantity estimated by the allocation estimator on the basis of the radio resource detected by the allocation state detector for each of the base stations on the basis of a distribution of the data received by the notification receiver and the received signal quality detected by the quality detector, wherein
the display unit displays the data related to the radio resource quantity estimated by the allocation estimator and corrected by the corrector for each of the base stations.

4. The mobile communication device according to claim 3, wherein the notified data received by the notification receiver indicates a modulation method and a coding method which the base station specifies for the mobile station other than the mobile communication device.

5. The mobile communication device according to claim 1, further comprising a radio resource quantity detector which detects a radio resource quantity which each of the base stations has, wherein
the allocation estimator estimates the radio resource quantity which can be allocated to the mobile communication device on the basis of the radio resource detected by the allocation state detector and the radio resource quantity detected by the radio resource quantity detector.

6. The mobile communication device according to claim 3, further comprising a radio resource quantity detector which detects a radio resource quantity which each of the base stations has, wherein
the allocation estimator estimates the radio resource quantity which can be allocated to the mobile communication device on the basis of the radio resource detected by the allocation state detector and the radio resource quantity detected by the radio resource quantity detector.

7. The mobile communication device according to claim 1, further comprising:
an instruction receiver which accepts an instruction of a user for selecting one of the base stations; and
a connection controller which connects the mobile communication device by radio to the base station accepted by the instruction receiver.

8. The mobile communication device according to claim 3, further comprising:
an instruction receiver which accepts an instruction of a user for selecting one of the base stations; and
a connection controller which connects the mobile communication device by radio to the base station accepted by the instruction receiver.

9. A method for estimating a radio resource allocated to a mobile communication device by one of a plurality of base stations included in a network upon the network including the mobile communication device as one of a plurality of mobile stations connected to the network, comprising:
detecting a radio resource that each of the base stations allocates to each of the mobile stations other than the mobile communication device;
estimating a radio resource quantity which can be allocated to the mobile communication device on the basis of the detected radio resource; and
displaying data related to the estimated radio resource quantity for each of the base stations.

10. The method for estimating a radio resource according to claim 9, further comprising:
detecting a quality of a signal received from each of the base stations;
receiving data notified by the base station to one of the mobile stations other than the mobile communication device, the notified data indicating a received signal quality; and
correcting the estimated radio resource quantity for each of the base stations on the basis of a distribution of the received data notified by the base station to one of the mobile stations other than the mobile communication device and the detected quality of the signal received from each of the base stations; wherein
the displayed data is related to the estimated and then corrected radio resource quantity for each of the base stations.
